(19) United States
(12) Patent Application Publication
(10) Pub. No.: US 2008/0263142 A1
(43) Pub. Date: Oct. 23, 2008

(54) Meta Data Driven User Interface System and Method

(75) Inventors: Richard A. Glass, Pittsburgh, PA (US); Wayne A. Daugherty, Bethel Park, PA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/104,738

(22) Filed: Apr. 17, 2008

Related U.S. Application Data
(60) Provisional application No. 60/913,155, filed on Apr. 20, 2007.

(51) Int. Cl. G06F 15/16

(52) U.S. Cl. 709/203

(57) ABSTRACT

A method comprises receiving a request for a webpage and retrieving metadata from a database. The metadata may be translated into one or more webparts. The method further comprises loading the one or more webparts onto the webpage and displaying the webpage.

### RELATED APPLICATIONS

This application claims the benefit under 35 U.S.C. § 119(e) of U.S. Provisional Application Ser. No. 60/913,155 filed Apr. 20, 2007. This application is being filed concurrently with U.S. Ser. No. ______, entitled “Method and System for Mapping Business Objects to Relational Database Tables” (Attorney Docket No. 063170.9046), which is incorporated by reference herein.

### TECHNICAL FIELD

This disclosure relates generally to relational databases, and more specifically to a system and method for a meta data driven user interface.

### BACKGROUND

Relational database management systems (RDBMS) include computer software designed for managing databases based on a variety of data models. An RDBMS may control organization, storage, management, and data retrieval in a database. More specifically, an RDBMS deals with databases where both the data and the relationship among the data is stored in the form of tables. Object-relational databases attempt to expand upon this, allowing developers to integrate a database with their own custom data-types and methods. Users may often desire to add or modify classes or business objects in these databases. However, this may require the insertion of additional code into the software underlying the database management system.

### SUMMARY OF EXAMPLE EMBODIMENTS

The present disclosure is directed to a system and method for generating a metadata-driven user interface. The teachings of the present disclosure may allow for a user interface that is dynamically rendered based on metadata.

In accordance with a particular embodiment of the present disclosure, a method comprises receiving a request for a webpage and retrieving metadata from a database. The metadata may be translated into one or more webparts. The webparts may be loaded onto the webpage, and the webpage may be displayed. More specifically, the one or more webparts may comprise one or more formlets and each formlet may comprise one or more control fields bound to metadata in the database.

In accordance with another aspect of the present invention, a system comprises an interface operable to receive a request for a webpage. The system further comprises a processor operable to retrieve metadata from a database, translate the metadata into one or more webparts, and load the one or more webparts onto the webpage. The interface is further operable to display the webpage.

In accordance with another aspect of the present invention, logic encoded in a computer readable medium is operable, when executed on a processor, to receive a request for a webpage and retrieve metadata from a database. The logic is further operable to translate the metadata into one or more webparts, load the one or more webparts onto the webpage, and display the webpage.

Technical advantages of particular embodiments of the present disclosure include a metadata-driven user interface. This may allow a user interface to be dynamically rendered based on metadata in a database. Further technical advantages of particular embodiments include the ability of a user to modify or customize the user interface by changing the metadata.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a schematic drawing illustrating a computer network configuration suitable for use within particular embodiments of the present disclosure;

FIG. 2 is a flow diagram illustrating a method for mapping business objects to relational database tables in accordance with particular embodiments of the present disclosure;

FIG. 3 is a schematic illustration of a user interface in accordance with particular embodiments of the present disclosure; and

FIG. 4 is a flow diagram illustrating a method for generating a user interface in accordance with particular embodiments of the present disclosure.

### DETAILED DESCRIPTION

Relational database tables are increasingly relied upon for various computing applications. Oftentimes, users may wish to update, expand, customize, or otherwise modify these applications. This may require the insertion of or modification of existing code, which may be less than desirable. Additionally, if various parties edit the code, the resulting application may lack uniformity of code.

In accordance with the teaching of the present disclosure, a system and method for mapping business objects to relational database tables is disclosed. An object of the present disclosure is to allow users to make alterations to an application based on modifications of metadata.

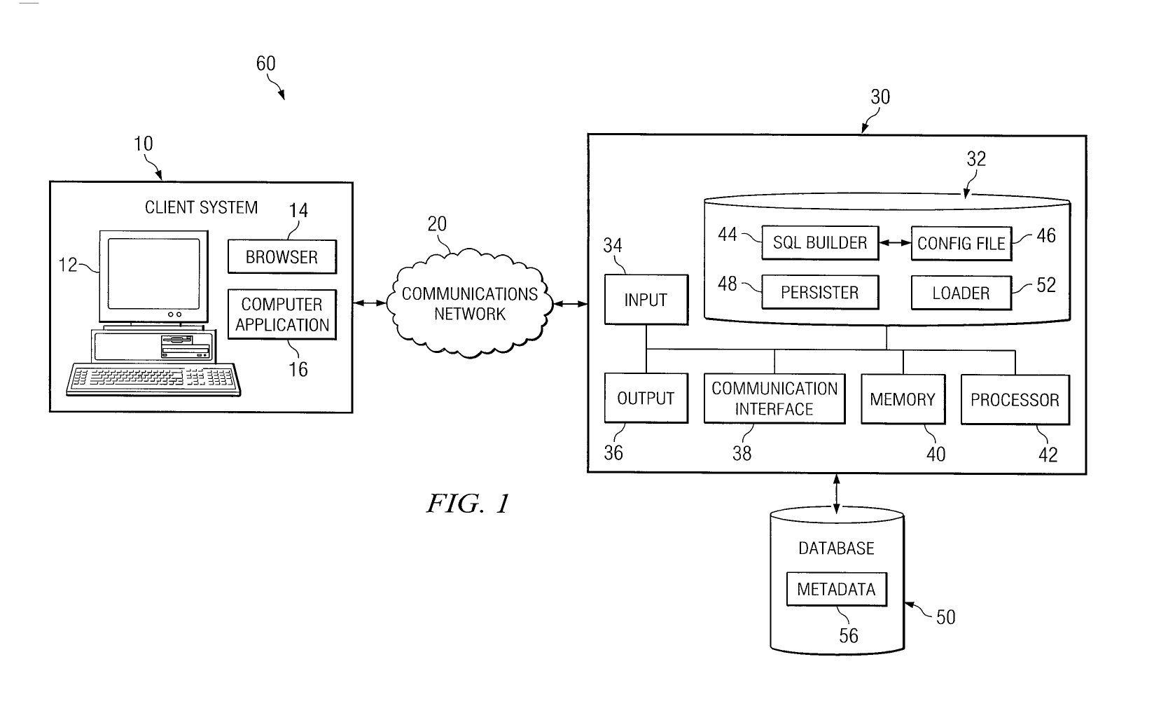

FIG. 1 illustrates a communications system, generally designated by reference numeral 60. Communications system 60 includes client system 10, communications network 20, server 30, and database 50.

Client system 10 includes a computer terminal 12, or other medium for accomplishing electronic communication. Terminal 12 may also include specific software including a browser 14 which allows standardized communication with network server 30. Terminal 12 may include additional software, such as computer application 16. Computer application 16 may be any computer application embodying teachings of the present disclosure. In particular embodiments, it may be a computer application utilizing object-relational databases, such as a software license management program.

Server 30 may refer to any device operable to deliver graphical images, videos, and other elements that are sent to the client system 10. According to the illustrated embodiment, server 30 includes storage device 32, an input device 34, an output device 36, a communication interface 38, a memory device 40, and a processor 42.

Input device 34 may refer to any suitable device operable to input, select, and/or manipulate various data and information. Input device 34 may include, for example, a keyboard, mouse, graphics tablet, joystick, light pen, microphone, scanner, or other suitable input device.

Output device 36 may refer to any suitable device operable for displaying information to a user. Output device 36 may include, for example, a video display, a printer, a plotter, or other suitable output device.

Communication interface 38 may refer to any suitable device operable to receive input for server 30, send output from server 30, perform suitable processing of the input or output or both, communicate to other devices, or any combination of the preceding. Communication interface 38 may include appropriate hardware (e.g. modem, network interface card, etc.) and software, including protocol conversion and data processing capabilities, to communicate through a LAN, WAN, or other communication system that allows server 30 to communicate to other devices. Communication interface 38 may include one or more ports, conversion software, or both.

Memory device 40 may refer to any suitable device operable to store and facilitate retrieval of data, and may comprise Random Access Memory (RAM), Read Only Memory (ROM), a magnetic drive, a Digital Video Disk (DVD) drive, removable media storage, any other suitable data storage medium, or a combination of any of the preceding.

Processor 42 may refer to any suitable device operable to execute instructions and manipulate data to perform operations for server 30. Processor 42 may include, for example, any type of central processing unit (CPU).

Storage device 32 may refer to any suitable device operable for storing data and instructions. Storage device 32 may include, for example, a magnetic disk, flash memory, optical disk, or other suitable data storage device. In the illustrated embodiment, storage device 32 comprises structured query language (SQL) builder 44, configuration file 46, persister 48, and loader 52.

SQL builder 44 may receive information and build actual SQL statements. These SQL statements may include, but are not limited to select clauses, update clauses, insert clauses, delete clauses, where clauses, join clauses, parameterized values, literal values, or create/drop table statements.

Configuration file 46 is a file that may contain information about which connection or command classes should be loaded by SQL builder 44. This may allow SQL builder 44 to determine the appropriate database type for the resulting SQL statement. In the illustrated embodiment, configuration file 46 and SQL builder 44 are shown as separate objects. However, in alternative embodiments, configuration file 46 may be incorporated into SQL builder 44, stored elsewhere on server 30, or stored in database 50.

Persister 48 may be capable of sending information and modifications to be saved in database 50. In the illustrated embodiment, persister 48 is shown as a separate element within storage device 32. In alternative embodiments, persister 48 may be incorporated within SQL builder 44 or located elsewhere on server 30.

Loader 52 may be capable of loading items or pulling data from database 50. In the illustrated embodiment, loader 52 is shown as a separate element within storage device 32. In alternative embodiments, loader 52 may be incorporated within SQL builder 44 or located elsewhere on server 30. Additionally, although persister 48 and loader 52 are portrayed as distinct elements, in particular embodiments, they may both be incorporated into one module or class.

Database 50 may be any database capable of storing information for use in a computer application. In particular, database 50 may be a relational database or an object-relational database. This may allow database 50 to store data in rows, columns, and tables, and also store information about the relationship between the data, rows, columns, and tables. This relationship information may take the form of metadata 56.

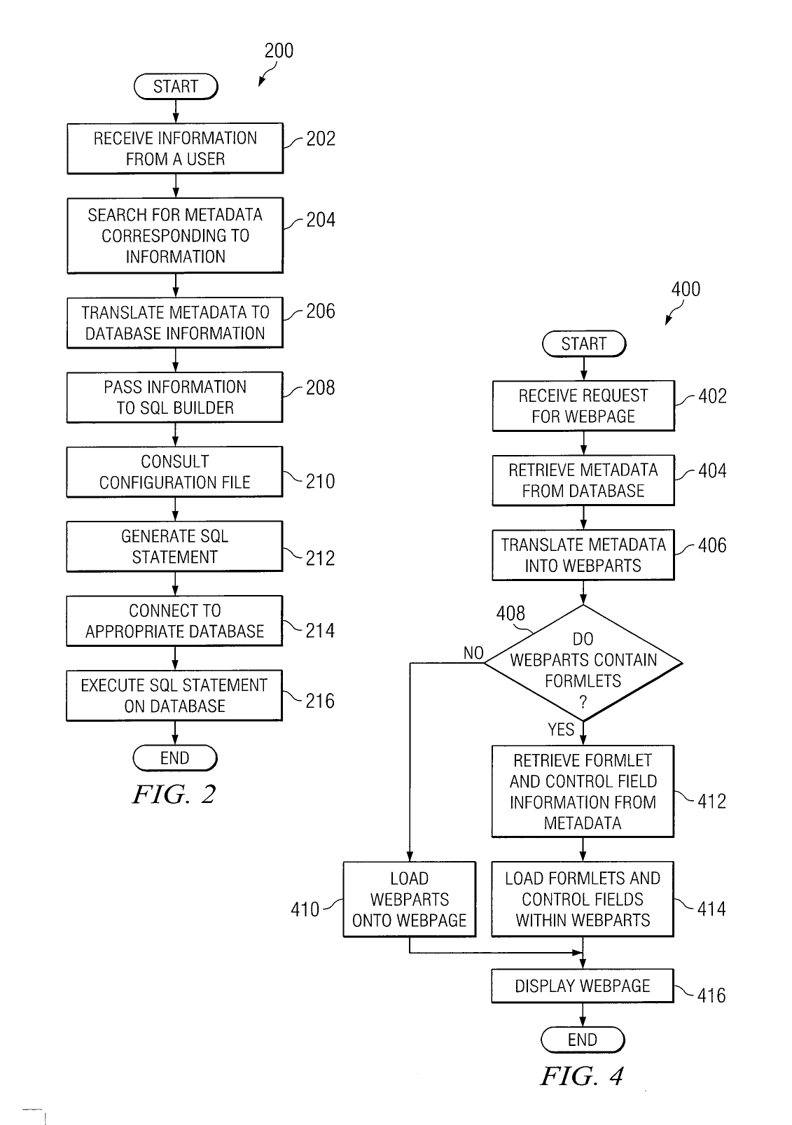

FIG. 2 is a flow diagram, designated generally be reference number 200, illustrating a method for mapping business objects to relational database tables in accordance with particular embodiments of the present disclosure. The specific steps of FIG. 2 will be described in detail below with reference to elements illustrated in FIG. 1.

The method begins at step 202, when information is received from a user. In the illustrated embodiment of FIG. 1, the user may be anyone using a computer application 16 on computer system 12, located on client system 10. Although only one computer system 12 is pictured, in alternative embodiments, multiple computer systems could be connected to server 30. For instance, in workplace or enterprise environments, many computer systems may run a common computer application connected to server 30. In these situations, a single user, such as a network administrator, may submit information, which may affect a single computer, several computers, or all computers connected to server 30.

The information received from the user may comprise, but is not limited to requests for information, additions, or modifications to a database 50. For instance, a user may request to add a column or table to a database, rename a column name, or update information within a database field. Traditionally, this would require a user or developer to manually write SQL statements or alter software code. In the illustrated embodiment, the user may submit this information to server 30 via communications network 20. In alternative embodiments, the elements of server 30, such as storage device 32 and database 50, may be incorporated into client system 10. This may occur when computer application 16 includes database 50, and both are installed onto computer system 12.

In many situations, SQL builder 44 may be unable to read or operate on this information provided by the user. For instance, the information provided by the user may be in the form of certain “high level” information, such as class names or attribute names corresponding to elements of database 50. In particular embodiments, SQL builder 44 may be unable to handle such high level information. SQL builder 44 may only be able to read and perform tasks based on the actual names of tables, columns, fields, etc. The type of information received from the user may depend on the computer application 16 being used or the specific user interface thereof.

In the event that the information cannot be read by SQL statement builder, metadata 56 may be relied upon, as shown at step 204. In general, metadata refers to data about data. In this particular embodiment, metadata 56 refers to data describing the tables, fields, foreign keys, and relationships of database 50, as well as data that describes the mapping from objects and their properties to the database tables and fields. Metadata 56 may be constructed at startup time as a singleton so that it can be accessed at multiple locations and at varying times. Metadata 56 may also be refreshed.

At this point, persister 48 may be employed. Persister 48 may map business entity classes, such as the high level material received from a user, into relational database 50. In particular embodiments, persister 48 may be used to map “CRUD” operations—create, read, update, or delete operations. Thus, persister 48 may be used to send information or modifications to database 50.

Depending on the desired operation, loader 52 may also be employed. Loader 52 may operate similarly to persister 48, but instead may map select operations based on metadata. Therefore, loader 52 may be used to load items or pull data from database 50 based on select statements received from a user. Although persister 48 and loader 52 are illustrated as distinct elements, in alternative embodiments they may be incorporated into one common element.

At step 206, this metadata may then be translated into information that SQL builder is able to read and operate on. Persister 48 and loader 52 may also be employed in this step. For instance, they may translate metadata about table names and column names into actual table names and column names that may be read by SQL builder 44.

After the metadata corresponding to the information has been found and translated, that specific information is passed to SQL builder 44 at step 208. SQL builder 44 may receive this information and programmatically generate an SQL statement to perform the task requested by the user. SQL statements may generally control transactions, program flow, connections, sessions, or diagnostics. In particular embodiments of this disclosure, SQL statements may be used to create, read, update, delete, or query data in database 50. SQL statements may additionally map object data to relational database 50.

For instance, a user may want to modify a column or table name within database 50. However, based on factors such as the user interface of computer application 16, the user's request may come in the form of an attribute name. Although SQL builder 44 is unable to read or handle this attribute name, metadata 56 may contain information that may be translated into the actual column or table name corresponding to the attribute name passed by the user.

At this point, SQL builder 44 may then consult configuration file 46, as shown by step 210. Configuration file 46 is a file that may contain information about which connection or command classes should be loaded by SQL builder 44. This may allow SQL builder 44 to determine the appropriate database type for the resulting SQL statement.

SQL builder 44 may rely on configuration file 46 to help directly access database 50. This may be accomplished using different software components for accessing data. According to particular embodiments, this may be accomplished through the use of ADO.Net. This may prevent other modules from having to deal with ADO.Net directly. Configuration file 46 may provide database type and connection string information so that the proper ADO.Net classes can be used. This may be particularly important for providing the correct database type. For instance, SQL databases may use different syntax than Oracle databases. Configuration file 46 may also hold a database user name. This user name may be appended to table names when generating SQL statements, which may ensure that the system is operating in the correct database or namespace. The use of SQL builder 44 in conjunction with configuration file 46 may automatically determine the appropriate database type, which may ensure proper syntax and operation.

At step 212, SQL builder 44 uses the information received from the user, metadata 56, translated information, and information from configuration file 46 to generate one or more SQL statements. For example, for a select statement, SQL builder 44 may create and put together select, for, and where clauses. The resulting SQL statements may be capable of performing the desired task requested by the user. Additionally, the SQL statement may hide the variations of different SQL “dialects” from the user. It may also hide some of the common tasks of building an SQL statement, such as prefix table names.

In alternative embodiments, the SQL statements generated may be parameterized. This may be used whenever a SQL statement needs values. These values may then be bound to the parameterized SQL statement. By doing this, the underlying data provider may handle the different format of values of various database types. This may eliminate the need to include value formatting functions. Additionally, it may allow for exchange of bulk information with database 50. If the same SQL statement can be executed for multiple values, a parameterized SQL statement allows the statement to be executed repeatedly with only the values changing. This may eliminate the need to re-create the entire SQL statement.

After the SQL statement is generated, SQL builder 44 connects to the appropriate database type at step 214. These database types may include, but are not limited to SQL and Oracle. This may be particularly helpful in applications using the Microsoft™.NET™ framework, because .NET data providers differ in many ways. For example, for parameter names, SQL Server provider uses “@parameterName,” Oracle uses “:ParameterName,” and some others may not even use parameter names. Information from configuration file 46 may allow SQL builder to handle these differences without requiring any user input or determination.

At step 216, the SQL statement is executed on database 50. At this point, the task requested by the user may actually be performed on database 50. For example, table names may be changed, columns may be added or deleted, etc. According to particular embodiments of the present disclosure, there may be four different types of execution of SQL statements. These may include ExecuteNonQuery, ExecuteRecord, ExecuteScaler, and ExecuteSingleRow.

ExecuteNonQuery may perform an action with no return expected by the user. An example of this may be a SQL statement that deletes some element from database 50. When executed, the SQL statement will simply delete the element, and the user does not expect some data to be returned.

ExecuteRecord may perform an action that returns a list of records with certain criteria. For example, a user may search for all licenses that start with the letter “M.” This would return a list of records that could then be displayed to the user. This option may be helpful if the user is unsure if more than one record is going to be returned.

Alternatively, ExecuteScaler may perform an action that returns only a single value. This may be convenient if the user is curious about one particular value in a record. For instance, when using a select statement, a user may only ask for one value in the select clause to be returned, instead of multiple columns in a table.

The final type of execution is ExecuteSingleRow. This type may only return the first record that the database returns, regardless of how many records are actually returned by the search. An example of this type may be when a user chooses a license from a license search screen and wants to make sure that no more than one license is returned. Because of this functionality, a user may use this type of execution when the user is certain that only one record will be returned, or if the user is only concerned with the first record returned. In this latter case, the “Order By” clause of the SQL statement may be used to determine which record is the first one displayed.

Additionally, the execution of SQL statements may also employ transaction scopes. This may allow activities to be put together. For instance, a user may desire to execute multiple related statements. However, the user may desire that either all of the statements are executed, or none. Using transaction scopes, these statements may be grouped together, such that if one fails, none of the statements are executed. This may provide roll back functionality, preventing a user from losing data in the database.

It should be understood that some of the steps illustrated in FIG. 2 may be combined, modified, or deleted where appropriate, and additional steps may also be added to the flow diagram.

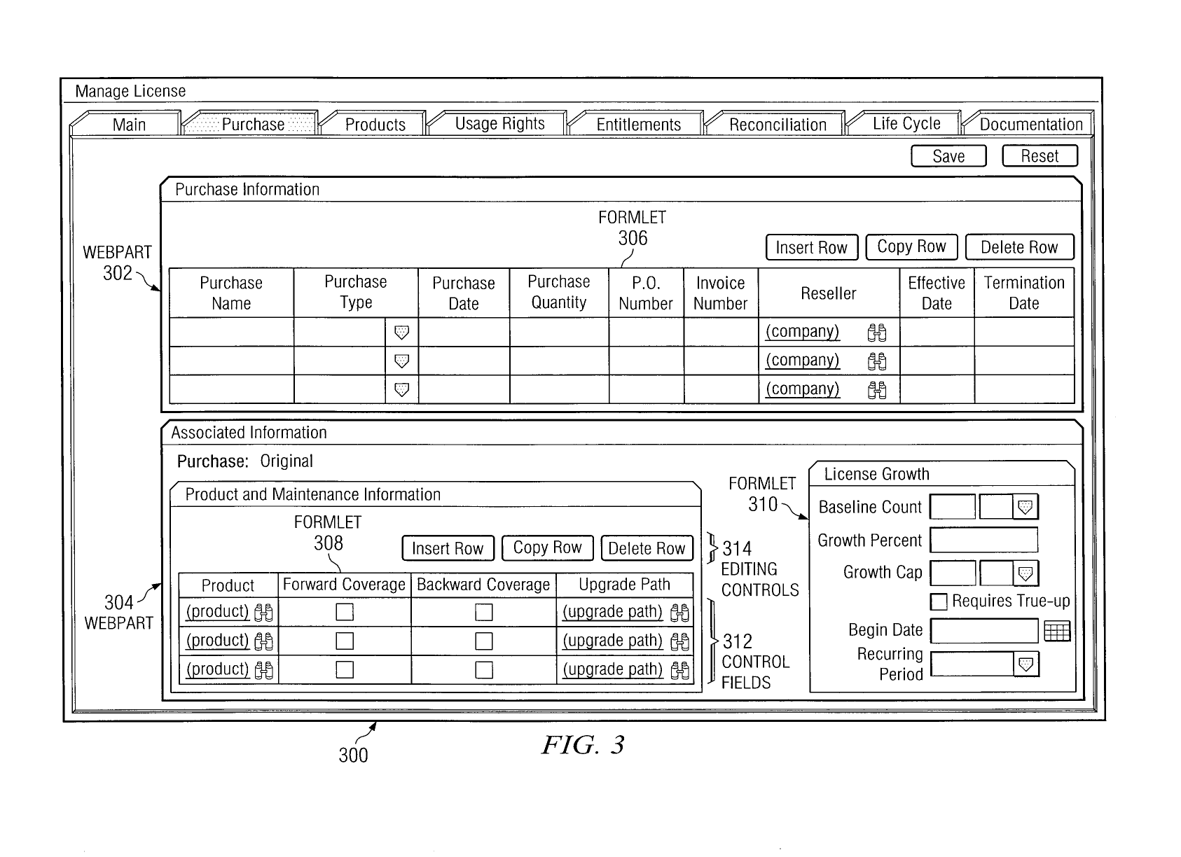

The teachings of the present disclosure may be incorporated into many different computer applications. For illustrative purposes, much of the remaining written description will refer to particular embodiments related to a software license management application. FIG. 3 is a schematic illustration of a webpage interface 300 of this application in accordance with particular embodiments of the present disclosure. Webpage 300 includes webparts 302 and 304 and formlets 306, 308, and 310.

Webparts may comprise an integrated set of controls for creating a website. They may enable users to modify the content, appearance, and behavior of webpages directly from a browser or user interface. In the illustrated embodiment, webpage 300 includes webparts 302 and 304. In the license management example illustrated, webpart 302 corresponds to “Purchase Information,” while webpart 304 corresponds to “Associated Information.”

Webparts may generally include formlets. Formlets house controls that may be bound to data or metadata in database 50. For instance, they may include, but are not limited to, text boxes, check boxes, or drop-down menu. In the illustrated embodiment, webpart 302 houses formlet 306, and webpart 304 houses formlets 308 and 310. In the illustrated embodiment, the formlet controls are generally designated by control fields 312.

In the license management example illustrated, formlet 306 includes various purchase information, such as name, type, date, and quantity. In the illustrated embodiment, formlet 306 is displayed in a “spread” or “grid” format, with listings for multiple records.

In the illustrated embodiment, formlet 308 includes product and maintenance information. Formlet 308 further comprises control fields regarding “Product,” “Forward Coverage,” “Backward Coverage,” and “Upgrade Path.” These control fields are generally designated by reference number 312. (more about control fields) Formlet 308 is also displayed in a grid format, with listings for multiple records.

In the license management example illustrated, formlet 310 includes license growth information. Unlike the previous two formlets, formlet 310 is displayed in a “form” format, with information related to a single record only.

As mentioned previously, webparts may allow a user to modify the content, appearance, and behavior of webpage 300. In particular embodiments, this may specifically be accomplished through the use of webpart controllers, designated by reference number 314. In the illustrated embodiment, these include controls for inserting, copying, and deleting rows. However, it can be appreciated that numerous other controls may be included for modifying webpage 300.

FIG. 4 is a flow diagram, designated generally by reference number 400, illustrating a method for generating a user interface in accordance with particular embodiments of the present disclosure. The specific steps of FIG. 2 will be described in detail below with reference to elements illustrated in FIGS. 1 and 3.

The process begins at step 402, when a request for a webpage is received from a user. The user may be any person using computer system 12. The request for the webpage may come in the form of typing a URL, following a link, or refreshing an existing webpage.

In some instances, webparts may already have been loaded onto the webpage. In these situations, the webparts may be stored in a personalization provider class for ease of re-loading. However, if the webparts have not been loaded onto webpage 300 yet, the webparts may be generated. This process begins at step 404, where metadata 56 is retrieved from database 50. Metadata may refer to data describing the tables, fields, foreign keys, and relationships of database 50, as well as data that describes the mapping from objects and their properties to the database tables and fields. In particular embodiments of the present disclosure, this metadata 56 may define which webpart or webparts should be loaded for a given application or webpage. Additionally, metadata 56 may define how those webparts are displayed or arranged on a screen.

At step 406, metadata 56 is translated into actual webparts. Webparts may comprise an integrated set of controls for creating a website. They effectively house functional elements and may enable users to modify the content, appearance, and behavior of webpages directly from a browser or user interface. The process of translation may include creating a physical control from the metadata record and then converting the control to a webpart. After all metadata has been converted, the system may check to see if all of the necessary webparts have been added to the webpage. After the webparts have been added, they may be added to a personalization profile. That way, after webparts have been generated from metadata and loaded onto a webpage, they can be retrieved from the personalization profile, eliminating the need to repeated access information from the metadata and re-generate webparts. Whenever new webparts are generated, they may be flagged for future saving to the personalization profile.

At step 408, the system checks to see if webpage 300 contains formlets. If not, the webparts may be loaded to the webpage at step 410.

However, in many cases, webparts will house formlets. In these situations, formlets and control fields may be loaded. Similar to the loading of webparts, this may begin by retrieving information from metadata, as shown at step 412. Formlets house controls that may be bound to data or metadata in database 50. This means they may refer to database 50 and display information from the database. For instance, controls may include, but are not limited to, text boxes, check boxes, or drop-down menu. Metadata 56 may provide information on which formlets are associated with given webparts, as well as information about the organization, grouping, and display of formlets on a webpage.

At step 414, after information is retrieved from metadata 56, the formlets and their control fields may be loaded within their respective webparts. For instance formlet 308, including control fields 312, may be loaded into webpart 304. Similar to the webparts, once formlets and control fields are loaded, they may be stored in the personalization profile. This may allow for easier access in the future, without having to pull from the metadata.

At step 416, webpage 300, including loaded webparts 302 and 304 and formlets 306, 308, and 310, are displayed. The formlets may correspond to records in database 50. In certain embodiments, this information may be displayed in a grid format, displaying fields for multiple records. This can be seen in formlet 308, which displays product and maintenance information for various software license products. Alternatively, formlets may display data for just a single record. This can be seen in formlet 310, which displays information for a single record pertaining to license growth.

As mentioned previously, the use of webparts may allow for a user to customize a display or user interface. For instance, a user may want to change the name of webpart 302 from “Purchase Information” to “License Purchase Information.” Alternatively, a user may want to delete the column “P.O. Number” from formlet 306. These, and many other changes may be made by the user. According to particular embodiments of the present disclosure, webparts and formlets may be governed by metadata 56. Therefore, modifications to the user interface may be accomplished by modifying the metadata 56. In these instances, the actual modifications may follow the steps enumerated in FIG. 2.

In particular embodiments, this may require a user to manually access database 50 and alter the desired metadata 56. In alternative embodiments, computer application 16 may include an additional graphical user interface or similar functionality to allow a user to more easily make these changes. In the illustrated embodiment, some of this functionality is represented by editing controls 314. In the illustrated embodiment, these controls include buttons to insert, copy, or delete a row. The use of these controls may automatically access the metadata and perform the user's desired modification.

It should be understood that some of the steps illustrated in FIG. 4 may be combined, modified, or deleted where appropriate, and additional steps may also be added to the flow diagram.

In addition to the advantages enumerated above, various embodiments of the present disclosure provide other benefits. For instance, the present disclosure may allow a user to more easily map business objects to relational database tables. Furthermore, the teachings of the present disclosure may allow a user to more easily perform operations on a database by altering metadata. This may allow a user to customize various aspects of a computer application, such as the user interface. Various other advantages may be readily apparent to one having skill in the art.

Although the present invention has been described in detail, it should be understood that various changes, substitutions, and alterations can be made without departing from the spirit and scope of the invention as defined by the appended claims.

What is claimed is:

1. A method, comprising:
receiving a request for a webpage;
retrieving metadata from a database;
translating the metadata into one or more webparts;
loading the one or more webparts onto the webpage; and
displaying the webpage.

2. The method of claim 1, wherein the metadata defines a number and arrangement of the webparts to be displayed on the webpage.

3. The method of claim 1, wherein the one or more webparts comprise one or more formlets, wherein each formlet comprises one or more control fields.

4. The method of claim 3, wherein displaying the webpage comprises displaying the control fields corresponding to one record.

5. The method of claim 3, wherein displaying the webpage comprises displaying the control fields corresponding to a plurality of records.

6. The method of claim 3, wherein the one or more control fields are bound to the metadata in the database.

7. The method of claim 6, wherein the metadata further defines a number and arrangement of control fields to be displayed within a webpart.

8. The method of claim 7, further comprising:
altering the metadata;
based on alterations to the metadata, altering the number and arrangement of control fields to be displayed within a webpart
re-loading the webparts; and
displaying an updated webpage.

9. The method of claim 8, wherein altering the metadata comprises:
accessing the database; and
manually altering the metadata in the database.

10. The method of claim 8, wherein altering the metadata comprises:
entering desired alterations into a graphical user interface; and
automatically making the desired alterations to the metadata in the database.

11. A system, comprising:
an interface operable to receive a request for a webpage;
a processor operable to:
retrieve metadata from a database;
translate the metadata into one or more webparts;
load the one or more webparts onto the webpage; and
the interface further operable to display the webpage.

12. The system of claim 11, wherein the metadata defines a number and arrangement of the webparts to be displayed on the webpage.

13. The system of claim 11, wherein the webparts comprise formlets, wherein each formlet comprises one or more control fields.

14. The system of claim 13, wherein the one or more control fields are bound to the metadata in the database.

15. The system of claim 13, wherein the metadata further defines a number and arrangement of control fields to be displayed within a webpart.

16. The system of claim 11, further comprising a graphical user interface operable to receive desired alterations from a user and automatically make the desired alterations to the metadata in the database.

17. Logic encoded in a computer readable medium and operable, when executed on a processor to:
receive a request for a webpage;
retrieve metadata from a database;
translate the metadata into one or more webparts;
load the one or more webparts onto the webpage; and
display the webpage.

18. The logic of claim 17, wherein the metadata defines a number and arrangement of the webparts to be displayed on the webpage.

19. The logic of claim 17, wherein the webparts comprise formlets, wherein each formlet comprises one or more control fields.

20. The logic of claim 19, wherein the one or more control fields are bound to the metadata in the database.

21. The logic of claim 19, wherein the metadata further defines a number and arrangement of control fields to be displayed within a webpart.

22. The logic of claim 17, wherein the logic is further operable to:
receive, via a graphical user interface, desired alterations; and
automatically make the desired alterations to the metadata in the database.
